(19) United States
(12) Patent Application Publication
(10) Pub. No.: US 2010/0108829 A1
(43) Pub. Date: May 6, 2010

(54) SUPPORT STAND FOR FLAT-PANEL DISPLAY MONITOR AND ELEVATING SUPPORT USED FOR SUPPORT STAND

(75) Inventor: FAN ZHOU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY(ShenZhen)CO., LTD., Shenzhen City (CN); HON HAI PRECISION INDUSTRY CO., LTD., Tu-Cheng (TW)

(21) Appl. No.: 12/463,503

(22) Filed: May 11, 2009

(30) Foreign Application Priority Data
Nov. 3, 2008 (CN) 200810305370.0

(51) Int. Cl. F16M 11/24

(52) U.S. Cl. 248/125.1; 248/125.7

(57) ABSTRACT

The support stand for a flat-panel display monitor includes a rotatable bracket, and an elevating support rotatably connected to the rotatable bracket. The elevating support includes a base member and a connecting module. First end portions of the first and second link brackets are rotatably connected to the connecting module, second end portions of the first and second link brackets are rotatably connected to the base member. The connecting module includes a connecting member and two pivotal shafts. The connecting member forms two protruding poles on two ends. Each protruding pole defines a positioning hole. Each pivotal shaft extends through the first end portion of each of the first and second link brackets, and engages with the positioning hole of each protruding pole.

### BACKGROUND

1. Technical Field

The present disclosure generally relates to support stands and elevating supports, particularly, to a support stand for a flat-panel display monitor and an elevating support.

2. Description of Related Art

Flat-panel display monitors, such as liquid crystal display monitors, offer advantages over cathode ray tube displays, such as reduced size, smaller weight, and better image quality. A viewing angle and height of the flat-panel display monitor can be adjusted without moving a support stand of the flat-panel display monitor because of its small weight.

A typical support stand generally includes a rotatable bracket to attach to the flat-panel display monitor, a base member, and an elevating mechanism rotatably mounted between the rotatable bracket and the base member. The elevating mechanism includes a first link shaft, a second link shaft, a connecting piece and a supporting block. First end portions of the first and second link shafts are rotatably assembled on two ends of the connecting piece, and second end portions of the first and second link shafts are rotatably assembled on two ends of the supporting block. The height of the flat-panel display monitor is changed by the motion of the elevating mechanism.

However, the connecting piece may be easily abraded or damaged by an exterior force due to the low structural strength. As a result, a stability of the typical support stand during the movement may be decreased, and a usage life of the typical support stand may be shortened.

What is needed, therefore, is a new support stand for a flat-panel display monitor and an elevating support that overcome the above mentioned disadvantages.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an assembled, isometric view of one embodiment of a support stand for a flat-panel display monitor, the support stand including one embodiment of an elevating support.

FIG. 2 is an exploded, isometric view of the elevating support in FIG. 1.

### DETAILED DESCRIPTION

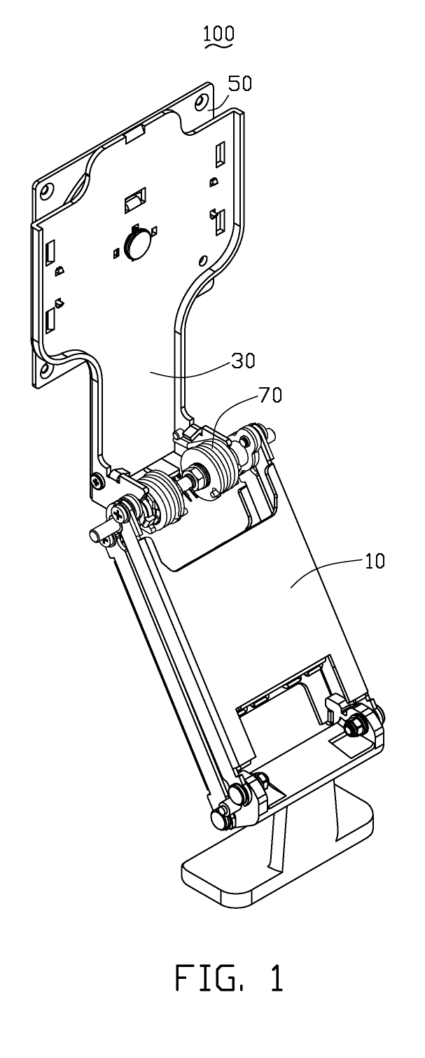

Referring to FIG. 1, one embodiment of a support stand 100 for a flat-panel display monitor includes one embodiment of an elevating support 10, a rotatable bracket 30, a monitor bracket 50, and two hinge assemblies 70. The elevating support 10 is rotatably connected to the rotatable bracket 30 by the hinge assemblies 70. The monitor bracket 50 is fixed on the rotatable bracket 30 to hold the flat-panel display monitor.

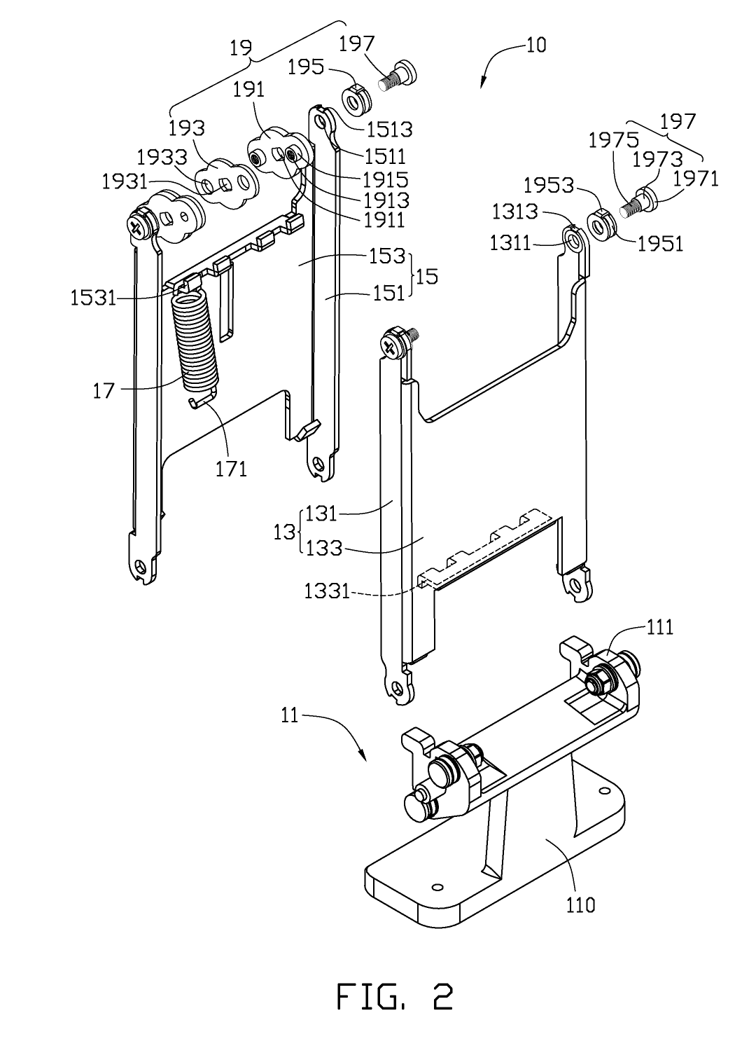

Referring also to FIG. 2, the elevating support 10 includes a base member 11, a first link bracket 13, a second link bracket 15, a plurality of tension springs 17, and a plurality of connecting modules 19. In the illustrated embodiment, there are two connecting modules 19.

The base member 11 includes a substantially I-shaped holder 110, and two supporting blocks 111 extending substantially perpendicularly from opposite ends of a top portion of the holder 110.

A first link bracket 13 may be substantially H-shaped, and includes a link sheet 133 and two side walls 131 extending substantially perpendicularly from opposite sides of the link sheet 133. The link sheet 133 includes at least one latching hook 1331 formed at a bottom end. A first end portion of each side wall 131 defines a substantially circular hole 1311 and a latching groove 1313. A second end portion of each side wall 131 opposite to the first end portion is rotatably assembled on the supporting block 111 of the base member 11.

The second link bracket 15 is similar in principle to the first link bracket 13. The second link bracket 15 may also be substantially H-shaped and includes a link sheet 153. The link sheet 153 includes at least one latching hook 1531 formed at a top end. The second link bracket 15 also includes two side walls 151 extending substantially perpendicularly from opposite sides of the link sheet 153. A first end portion of each side wall 151 defines a substantially circular hole 1511, and a latching groove 1513. A second end portion of each side wall 151 is rotatably assembled on the supporting block 111 of the base member 11.

Each tension spring 17 includes two hooks 171 extending from opposite end portions of the tension spring 17 to latch on the corresponding latching hooks 1331, 1531.

Each connecting module 19 includes two pivotal shafts 197, a connecting member 191, a strengthening member 193, and two protecting members 195.

Each pivotal shaft 197 includes a flange 1971, and a shaft portion 1973 extending from the flange 1971 along an extending direction of the pivotal shaft 197. A threaded portion 1975 is formed on an end of the shaft portion 1973 opposite to the flange 1971.

The connecting member 191 defines a deformed through hole 1911 in a middle portion, and forms two protruding poles 1915 on two ends of the connecting member 191. Each of the protruding poles 1915 defines a positioning hole 1913. The positioning hole 1913 is a threaded hole to engage with the threaded portion 1975 of the pivotal shaft 197.

The strengthening member 193 defines a deformed through hole 1931 in a middle portion, and two substantially circular through holes 1933 in two ends corresponding to the two protruding poles 1915 of the connecting member 191. A diameter of the substantially circular through hole 1933 is slightly smaller than the outer diameter of the protruding pole 1915 such that the protruding pole 1915 can be tightly fixed in the substantially circular through hole 1933.

Each protecting member 195 includes a pair of washers 1951 positioned opposite to each other, and a latching tab 1953 connecting the pair of washers 1951. The latching tab 1953 is latched in the corresponding latching grooves 1313, 1513, so that the pair of washers 1951 is fixed on opposite sides of the side wall 131, 151, thus protecting the side walls 131, 151 from abrasion. In alternative embodiments, the connecting member 191 and the protecting member 195 may be made of plastic materials having a self-lubricating property, or define a plurality of lubricant grooves in side surfaces of the protecting member 195, to reduce abrasion of the pivotal shaft 197.

To assemble the elevating support 10, one hook 171 of the tension spring 17 is fixed to the latching hook 1331 of the first link bracket 13 and the other hook 171 is fixed to the latching hook 1531 of the second link bracket 15. The latching tab 1953 is latched in the latching groove 1313, so that the pair of the washers 1951 is fixed on the opposite sides of the side wall 131. The protruding poles 1915 of the connecting member 191 are fixed in the substantially circular through holes 1933 of the strengthening member 193. The shaft portion 1973 of the pivotal shaft 197 passes through one washer 1951, the substantially circular hole 1311 of the side wall 131, and the other washer 1951. The threaded portion 1975 of the pivotal shaft 197 engages in one positioning hole 1913 of the connecting member 191. Hence, the first end portion of the first link bracket 13 is rotatably assembled on one end of the connecting member 191. Accordingly, the corresponding first end portion of the second link bracket 15 is rotatably assembled on the other end of the connecting member 191. The corresponding second end portions of the first and second link brackets 13, 15 are rotatably assembled on two ends of the supporting block 111 of the base member 11.

After the elevating support 10 is assembled, a rotatable shaft (not labeled) of the hinge assembly 70 passes through the deformed through hole 1911 of the connecting member 191, the deformed through hole 1931 of the strengthening member 193, the rotatable bracket 30, and other components of the hinge assembly 70, such as a frictional member (not labeled), an elastic member (not labeled), and a fastening member (not labeled). Thus, the elevating support 10 is rotatably connected to the rotatable bracket 30.

When the support stand 100 is used for supporting a flat-panel display monitor, the monitor bracket 50 is fixed to a display body (not shown) of the flat-panel display monitor. In use, a force is applied on the display body to drive the display body with the rotatable bracket 30 to rotate along an axis of the hinge assembly 70 relative to the elevating support 10, thereby adjusting the viewing angle of the flat-panel display monitor. The display body can be stably maintained at a desired angle relative to the elevating support 10 due to the frictional forces generated between the components of the hinge assembly 70.

When the height of the display body needs to be adjusted, the display body can be pushed upwards or downwards to increase or decrease the height of the display body via the elevating support 10. During the adjusting process, the height of the flat-panel display monitor changes, but the viewing angle of the flat-panel display monitor remains the same. When the flat-panel display monitor is lifted to a desired height, the flat-panel display monitor can be stably maintained at the desired height by frictional forces generated between the components of the connecting modules 197. An elastic force of the tension spring 17 either increases or decreases according to the motion of the elevating support 10, thereby preventing the support stand 100 from damage by excessive forces.

The protruding poles 1915 are integrally formed with the connecting member 191 to increase the structural strength of the connecting member 191. The strengthening member 193 is fixed to the connecting member 191 to further increase the structural strength of the connecting member 191. Therefore, during the motion of the elevating support 10, the connecting member 191 is not easily abraded or damaged by external forces, so that the support stand 100 has a high stability and a long usage life. In addition, the pivotal shaft 197 engages in the positioning hole 1913 of the connecting member 191, thus omitting a fastening member, and increasing the engaging area of the pivotal shaft 197 and the connecting member 191, so that the stability of the support stand 100 is further increased. Moreover, the protecting member 195 protects the first and second link brackets 13, 15 from abrasion, so the usage life of the support stand 100 is further prolonged.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A support stand for a flat-panel display monitor, comprising:
a rotatable bracket;
an elevating support rotatably connected to the rotatable bracket, the elevating support comprising:
a base member;
a connecting module comprising a connecting member and a pivotal shaft, the connecting member forming a protruding pole thereon, and defining a positioning hole in the protruding pole;
a first link bracket comprising a first end portion and a second end portion; and
a second link bracket comprising a first end portion and a second end portion, the first end portions of the first and the second link brackets being rotatably connected to the connecting module, the second end portions of the first and the second link brackets being rotatably connected to the base member;
wherein the pivotal shaft extends through the first end portion of one of the first and second link brackets, and engages in the positioning hole of the protruding pole.

2. The support stand of claim 1, wherein the connecting module further comprises a strengthening member defining a substantially circular through hole corresponding to the protruding pole of the connecting member; a diameter of the substantially circular through hole is smaller than the outer diameter of the protruding pole such that the protruding pole is fixed in the substantially circular through hole of the strengthening member.

3. The support stand of claim 1, wherein the pivotal shaft forms a threaded portion on an end; the positioning hole is a threaded hole to engage with the threaded portion of the pivotal shaft.

4. The support stand of claim 1, wherein the first end portion of one of the first and second link brackets defines a latching groove; the connecting module further comprises a protecting member comprising a pair of washers positioned opposite to each other, and a latching tab connecting the pair of washers; the latching tab is latched in the latching groove of the first end portion, so that the pair of washers are fixed on opposite sides of one of the first and second link brackets.

5. The support stand of claim 1, wherein the protecting member is made of plastic materials having a self-lubricating property.

6. The support stand of claim 1, wherein the base member comprises a substantially I-shaped holder, and a supporting block extending substantially perpendicularly from an end of a top portion of the holder.

7. The support stand of claim 6, wherein the first end portions of the first and the second link brackets are rotatably assembled on two ends of the connecting member; the second end portions of the first and the second link brackets are rotatably assembled on two ends of the supporting block.

8. The support stand of claim 1, wherein each of the first and the second link brackets is substantially H-shaped, and comprises a link sheet and two side walls extending from two sides of the link sheet; the first end portion and the second end portion are formed at two ends of each side wall.

9. The support stand of claim 8, wherein the link sheet of the first link bracket comprises a latching hook formed at a bottom end thereof and the link sheet of the second link bracket comprises a latching hook formed at a top end thereof; the elevating support further comprises a tension spring having two hooks extending from opposite end portions thereof, one hook of the tension spring is fixed to the latching hook of the first link bracket and the other hook of the tension spring is fixed to the latching hook of the second link bracket.

10. An elevating support, used for a support stand of a flat-panel display monitor, the elevating support comprising:
a first link bracket comprising a first end portion and a second end portion;
a second link bracket comprising a first end portion and a second end portion;
a connecting member rotatably connecting first end portions of the first and the second link brackets, the connecting member forming a protruding pole thereon, and defining a positioning hole in the protruding pole;
a supporting block rotatably connecting second end portions of the first and the second link brackets; and
a pivotal shaft extending through the first end portion of one of the first and second link brackets, and engaging in the positioning hole of the protruding pole.

11. The elevating support of claim 10, further comprising a strengthening member defining a substantially circular through hole corresponding to the protruding pole of the connecting member; wherein a diameter of the substantially circular through hole is smaller than the outer diameter of the protruding pole, such that the protruding pole is fixed in the substantially circular through hole of the strengthening member.

12. The elevating support of claim 10, wherein the pivotal shaft forms a threaded portion on an end; the positioning hole is a threaded hole to engage with the threaded portion of the pivotal shaft.

13. The elevating support of claim 10, wherein the first end portion of one of the first and second link brackets defines a latching groove; the elevating support further comprises a protecting member comprising a pair of washers positioned opposite to each other, and a latching tab connecting the pair of washers; the latching tab is latched in the latching groove of the first end portion, so that the pair of washers are fixed on opposite sides of one of the first and second link brackets.

14. The elevating support of claim 13, wherein the protecting member is made of plastic materials having a self-lubricating property.

15. The elevating support of claim 10, further comprising a base member, wherein the base member comprises a substantially I-shaped holder, the supporting block extending substantially perpendicularly from an end of a top portion of the holder.

16. The elevating support of claim 10, wherein each of the first and the second link brackets is substantially H-shaped, and comprises a link sheet and two side walls extending from two sides of the link sheet; the first end portion and the second end portion are formed at two ends of each side wall.

17. The elevating support of claim 16, wherein the link sheet of the first link bracket comprises a latching hook formed at a bottom end thereof and the link sheet of the second link bracket comprises a latching hook formed at a top end thereof; the elevating support further comprises a tension spring having two hooks extending from opposite end portions thereof, one hook of the tension spring is fixed to the latching hook of the first link bracket and the other hook of the tension spring is fixed to the latching hook of the second link bracket.
